(19) United States
(12) Patent Application Publication
(10) Pub. No.: US 2009/0074499 A1
(43) Pub. Date: Mar. 19, 2009

(54) PRINTER

(76) Inventors: Kazutaka Suzuki, Fukushima-ken (JP); Masayuki Oyane, Kagawa-ken (JP)

Correspondence Address: BRINKS HOFER GILSON & LIONE, P.O. BOX 10395, CHICAGO, IL, 60610, US

(21) Appl. No.: 12/209,678

(22) Filed: Sep. 12, 2008

(30) Foreign Application Priority Data
Sep. 14, 2007 (JP) 2007-238999

(51) Int. Cl. B41J 11/00

(52) U.S. Cl. 400/621

(57) ABSTRACT

A printer includes a cutter disposed inside a printer body to cut a roll-like recording medium having an image recorded thereon along a width direction orthogonal to a longitudinal direction of the recording medium, and a slitter cutting the recording medium in its longitudinal direction. The cutter is formed so as to be reciprocable along the width direction of the recording medium, and is formed such that the recording medium is cut along the width direction by the movement of the cutter in the width direction. The slitter is formed so as to be movable along the width direction of the recording medium such that the slitter selectively takes at least two positions including an initial position separated outward from an end edge of the recording medium in the width direction, and a cutting position where the recording medium is cut along the longitudinal direction, and is formed such that the recording medium is cut along the longitudinal direction by conveying the recording medium in a state where the position of the slitter is moved to the cutting position. A movable guide made movable in an interlocking manner with the movement of the cutter and guiding unnecessary portions of the recording medium cut by the cutter toward a garbage box arranged in a discarding section preset inside the printer body, and a moving guide moved along with the slitter and guiding unnecessary portions of the recording medium cut by the slitter toward the garbage box.

### RELATED APPLICATIONS

The present application contains subject matter related to Japanese Patent Application JP2007-238999 filed in the Japanese Patent Office on Sep. 14, 2007, the entire contents of which being incorporated herein by reference.

### BACKGROUND

1. Technical Field

The present invention relates to a printer, and particularly, to a printer suitable for separating a roll-like recording medium on which an image has been formed into a necessary portion on which an image is formed, and unnecessary portions including margins, on which an image is not formed.

2. Related Art

In the related art, a printer in which a wide ink ribbon, such as an ink film or an ink sheet, and a line thermal head having a length such that the head can face a recording range of a roll-like recording medium in its width direction via the recording medium are made to abut to a platen, and a plurality of heater elements of the line thermal head which are arrayed in the longitudinal direction of the platen and are corresponding to a recording width while the ink ribbon and the recording medium are conveyed in this abutting state are selectively driven and made to generate heat, on the basis of recording information, thereby transferring ink of the ink ribbon to the recording medium, is known (for example, refer to Japanese Unexamined Patent Application Publication No. 2000-263864).

Such a printer is used particularly for recording of an image which requires a number of gradations which can smoothly express changes in the color or brightness of photographs, etc.

The printer has a plurality of ink ribbons on which inks of a plurality of colors (for example, cyan (C), magenta (M), yellow (Y), black (BK), or an overcoat (OP)) are applied, respectively, and a plurality of recording heads corresponding to the number of the ink ribbons. These recording heads are arrayed at predetermined intervals along a conveying path of a recording medium, and each recording head is arranged so as to face the recording medium via an ink ribbon. Further, a platen is provided in a position which faces each recording head via each ink ribbon and a recording medium.

In the printer, when a first recording head, a second recording head, a third recording head, and a fourth recording head are arrayed from the most upstream side in the conveying direction of the recording medium, the first recording head, and the first platen that faces the first recording head are brought into pressure contact with each other if the recording start position of a recording medium arrives at the position which faces the first recording head. Specifically, the first recording head is turned down toward the first platen which faces the first recording head, or the first platen is turned down toward the first recording head. Then, for example, cyan (C) ink is transferred to the recording medium by the first recording head by bringing the first recording head and the first platen into pressure contact with each other via the recording medium and an ink ribbon.

Subsequently, when the recording start position arrives at a position which faces the second recording head, a second recording head is turned down, or a second platen which faces the second recording head is turned down. Then, magenta (M) ink is transferred from above the cyan (C) ink by the second recording head by bringing the second recording head and the second platen into pressure contact with each other via the recording medium and an ink ribbon.

As such, a desired color image is recorded on the recording medium by a plurality of inks by turning down the recording heads sequentially from the recording head on the upstream side in the conveying direction of the recording medium, or turning down the platens sequentially from the platen on the upstream side, thereby transferring inks to the recording medium.

Meanwhile, a roll-like recording medium on which an image has been formed is discharged from a printer after unnecessary portions, such as margins, which exist around a necessary portion on which an image is recorded, are removed.

Such unnecessary portions RB, as shown in FIG. 14, there are transverse margins RBa, as shown by hatched regions in FIG. 14, which exist in the width direction orthogonal to the longitudinal direction of the recording medium R, between images as necessary portions RA which are arrayed in the longitudinal direction of the recording medium R, at the leading side of a first image, and at a trailing side of a last image.

Further, as the unnecessary portions RB, for example, in a case where an image of 5-inch width is recorded on the recording medium R of 6-inch width, there are longitudinal margins RBb, as shown by broken hatched regions in FIG. 14, which exist along the longitudinal direction of the recording medium R at the ends of the recording medium R in its width direction, in addition to the transverse margins RBa.

For this reason, a cutter which cuts the recording medium R along the width direction in order to remove the transverse margins RBa, and a cutter which cuts the recording medium along the longitudinal direction in order to cut the longitudinal margins RBb are disposed inside a printer (for example, refer to Japanese Unexamined Patent Application Publication No. 2002-002040 (FIG. 1)).

However, in the related-art printer, there is a problem in that the unnecessary portions RB of the recording medium R cannot be surely separated from the necessary portions RA, and cannot thus be housed in a garbage box.

### BRIEF SUMMARY

It is desirable to provide a printer which can surely separate unnecessary portions of a recording medium from necessary portions to house them in a garbage box.

According to one embodiment of the invention, there is provided a printer including a cutter disposed inside a printer body to cut a roll-like recording medium having an image recorded thereon along a width direction orthogonal to a longitudinal direction of the recording medium, and a slitter cutting the recording medium in its longitudinal direction. The cutter is formed so as to be reciprocable along the width direction of the recording medium, and is formed such that the recording medium is cut along the width direction by the movement of the cutter in the width direction. The slitter is formed so as to be movable along the width direction of the recording medium such that the slitter selectively takes at least two positions including an initial position separated outward from an end edge of the recording medium in the width direction, and a cutting position where the recording medium is cut along the longitudinal direction, and is formed such that the recording medium is cut along the longitudinal direction by conveying the recording medium in a state where the position of the slitter is moved to the cutting position. A movable guide made movable in an interlocking manner with the movement of the cutter and guiding unnecessary portions of the recording medium cut by the cutter toward a garbage box arranged in a discarding section preset inside the printer body, and a moving guide moved along with the slitter and guiding unnecessary portions of the recording medium cut by the slitter toward the garbage box. By adopting such a construction, the movable guide can separate unnecessary portions cut by the cutter from necessary portions to surely guide them toward a garbage box. Further, the moving guide can surely separate unnecessary portions cut by the cutter from necessary portions to surely guide them toward a garbage box.

Preferably, the cutter is unified to form a cutter unit, the movable guide, the slitter and the moving guide are unified to form a slitter unit, in a state of being arranged in this order along a conveying direction of the recording medium, and the slitter unit is attached to the downstream side of the cutter unit in the conveying direction of the recording medium and is integrated with the cutter unit to form a cutting unit. By adopting such a construction, miniaturization and assembling workability can be easily improved.

Preferably, the cutter unit is provided with a cutter moving means reciprocating the cutter along the width direction of the recording medium, a motor for a cutter driving the cutter moving means, and a guide driving means driving the moving guide in an interlocking manner with the movement of the cutter such that the movable guide selectively takes two positions including a conveying position where the movable guide faces the conveying path so that the recoding medium can move along the conveying path, and a guiding position where the conveying path of the recording medium is blocked, the slitter unit is provided with a slitter moving means moving the slitter along the width direction of the recording medium between at least two positions including the initial position and the cutting position, a motor for a slitter driving the slitter moving means, a moving guide moving means moving the moving guide in an interlocking manner with the movement of the slitter, and a conveying means for a cutting section conveying necessary portions of the recording medium passed through the cutter unit to the downstream side in the conveying direction of the recording medium. By adopting such a construction, separating unnecessary portions of a recording medium from necessary portions to house them to a garbage box can be surely and easily performed.

According to the printer related to the embodiment of the invention, the movable guide can separate unnecessary portions cut by the cutter from necessary portions to surely guide them toward a garbage box. Further, the moving guide can surely separate unnecessary portions cut by the cutter from necessary portions to surely guide them toward a garbage box. Accordingly, excellent effects such that separating unnecessary portions of a recording medium from necessary portions to house them to a garbage box can be surely and easily performed are exhibited.

### BRIEF DESCRIPTION OF THE DRAWINGS

FIG. 1 is a schematic view showing the entire construction of a printer related to an embodiment of the invention;

FIG. 2 is an enlarged view of a portion A of FIG. 1;

FIG. 3 is an external perspective view showing major portions of a cutting unit of FIG. 1;

FIG. 4 is an enlarged sectional view of FIG. 3;

FIG. 5 is an external perspective view showing major portions of a cutter unit of FIG. 3;

FIG. 6 is a schematic view showing major portions of a cutter moving means of the cutter unit of FIG. 3;

FIG. 7 is an external perspective view showing major portions of a slitter unit of FIG. 3;

FIG. 8 is an enlarged bottom view showing major portions of FIG. 7;

FIG. 9 is an external perspective view showing major portions in a standby state of a movable guide of the cutting unit of FIG. 3;

FIG. 10 is a sectional view showing major portions in a standby state of the movable guide of the cutting unit of FIG. 3;

FIG. 11 is an external perspective view of major portions in a transverse margin cutting completion state by the cutting unit of FIG. 3;

FIG. 12 is a schematic view showing that the arrangement of a slitter of the slitter unit of FIG. 7 is seen from the upstream side in the conveying direction;

FIG. 13 is an external perspective view of major portions in a longitudinal margin cutting state by the slitter unit of FIG. 7; and

FIG. 14 is a schematic view showing the relationship between necessary portions and unnecessary portions of a recording medium.

### DETAILED DESCRIPTION OF THE DRAWINGS AND THE PRESENTLY PREFERRED EMBODIMENTS

Hereinafter, the invention will be described by an embodiment shown in the drawings.

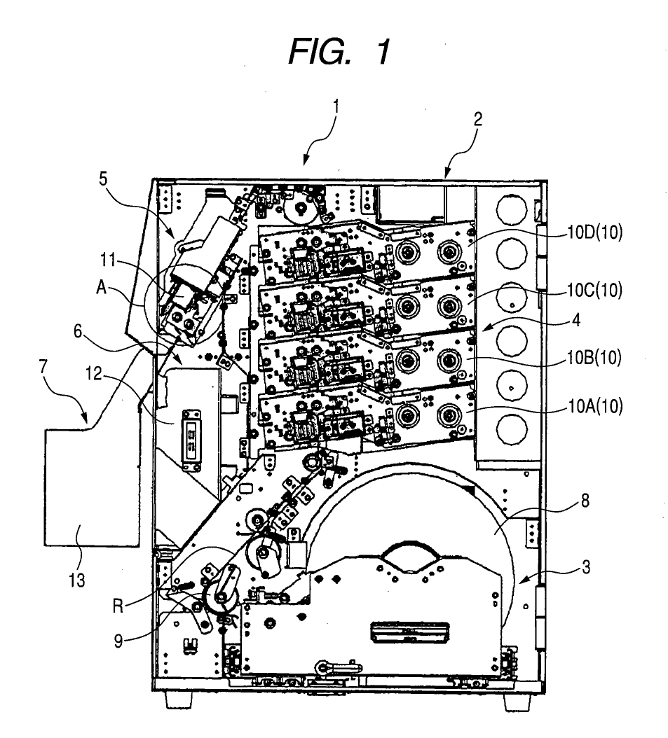

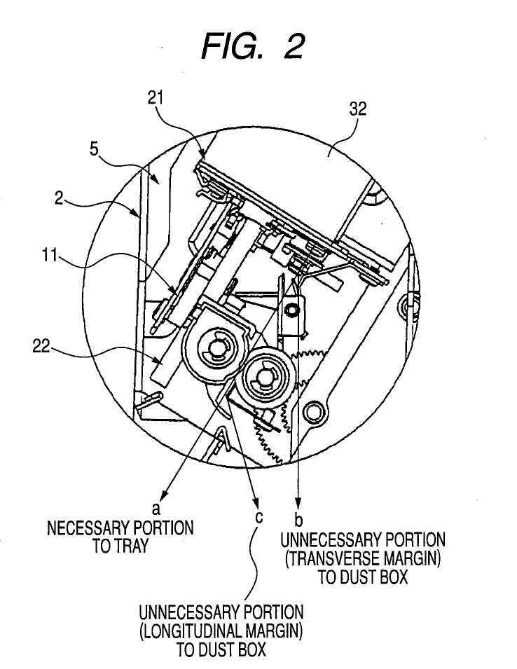

First, the outline of the entire construction of a printer related to an embodiment of the invention will be described with reference to FIG. 1 and FIG. 2.

FIG. 1 and FIG. 2 show the printer related to the embodiment of the invention, FIG. 1 is a schematic view showing the entire construction, and FIG. 2 is an enlarged view of a portion A of FIG. 1.

As shown in FIG. 1, the printer 1 of this embodiment has, inside a printer body 2, a supply section 3 disposed substantially horizontally along the right-left direction in a lower portion of FIG. 1, a recording section 4 disposed substantially perpendicularly along the up-down direction in a right portion of FIG. 1, a medium cutting section 5 disposed obliquely from the upper right toward the lower right in an upper left corner of FIG. 1, and a discarding section 6 disposed substantially in an intermediate portion of a left portion of FIG. 1 in the up-down direction. Further, outside the printer body 2, a medium housing unit 7 which faces the discarding section 6 via a side plate of the printer body 2 is disposed substantially in the intermediate portion of the left portion of FIG. 1 in the up-down direction.

Accordingly, inside the printer body 2 the supply section 3, the recording section 4, and the medium cutting section 5 are disposed so as to have a substantially inverted S shape as a whole, and a conveying path for a roll sheet R (refer to FIG. 14 and FIG. 8) as a roll-like recording medium is formed so as to have a substantially inverted S shape as a whole. In addition, as raw materials of the recording medium, various materials, such as paper and resin, can be used.

The supply section 3 is provided to hold the roll sheet R to be supplied to the recording section 4, and a supply roll 8 around which the roll sheet R is wound is detachably mounted on the supply section 3. Also, the roll sheet R is paid out from the supply roll 8 by the driving force of supply rollers (not shown), and is conveyed to the recording section 4 while being guided along a predetermined conveying path by guide means for supply, such as a guide plate (not shown) and a plurality of guide rollers 9 (in FIG. 1, reference numeral is given to one guide roller).

The recording section 4 is provided to record a desired image on the roll sheet R, and a plurality of (four in this embodiment) recording units 10 for carrying out full color recording are arrayed along the conveying path which runs from the upper side to the lower side in FIG. 1 as a whole in the recording section 4. The recording units 10 include a first recording unit 10A, a second recording unit 10B, a third recording unit 10C, and a fourth recording unit 10D which are arrayed in this order from the most upstream side in the conveying direction shown on the lower side of FIG. 1 to toward the downstream side shown on the upper side of FIG. 1.

Each of the recording units 10 arrayed in the recording section 4 has a line thermal head as a recording head, a platen roller as a platen, a head contact/separating mechanism causing the platen roller to be contacted with or separated from the line thermal head, a conveying means having a conveying roller, and a ribbon cassette, which are not shown, as publicly known in the related art.

As ink ribbons of the ribbon cassettes, for example, in order to record a full color image on the roll sheet R, an ink ribbon on which cyan (C) ink is coated is used as an ink ribbon of the first recording unit 10A, an ink ribbon 23 on which magenta (M) ink is coated is used as an ink ribbon of the second recording unit 10B, an ink ribbon on which yellow (Y) ink is coated is used as an ink ribbon of the third recording unit 10C, and an ink ribbon on which black (BK) ink or overcoat (OP) ink is coated is used as an ink ribbon of the fourth recording unit 10D.

The medium cutting section 5 is provided to cut the roll sheet R on which an image has been recorded by the recording section 4 with a predetermined length and width. A cutting section 11 (to be described) which can cut the roll sheet R in a direction along its longitudinal direction or in a direction along its width direction orthogonal to the longitudinal direction is disposed in the medium cutting section 5.

The discarding section 6 is provided to recover unnecessary portions RB (refer to FIG. 14), such as transverse margins RBa and longitudinal margins RBb, of the roll sheet R which are cut by a cutting unit 11 provided in the medium cutting section 5, and on which any image is not formed, and a garbage box 12 whose top is open is arranged in the discarding section 6. Also, the unnecessary portions RB formed by the medium cutting section 5 are formed so as to be discharged along discharge directions indicated by arrows b and c of FIG. 2 and enter the garbage box 12. Further, the garbage box 12 is detachably arranged in a state where a door (not shown) provided at a side surface of the printer body 2 is opened.

The medium housing unit 7 is provided to recover necessary portions RA (refer to FIG. 14) of the roll sheet R which are cut by the cutting unit 11 provided in the medium cutting section 5, and which have an image formed thereon, and a tray 13 whose top is open is arranged in the medium housing unit 7. Also, the necessary portions RA which are discharged from the medium cutting section 5 and which have an image formed thereon are formed so as to be discharged along a conveying direction (hereinafter simply referred to as conveying direction) of a recording medium, which is indicated by an arrows a of FIG. 2 and enter the tray 13. Further, the tray 13 is detachably attached to a side surface of the printer body 2. In addition, the necessary portions RA of the roll sheet R are discharged by a conveying roller 39 for a cutting section (to be described later) of the cutting unit 11, and is housed one by one in the tray 13.

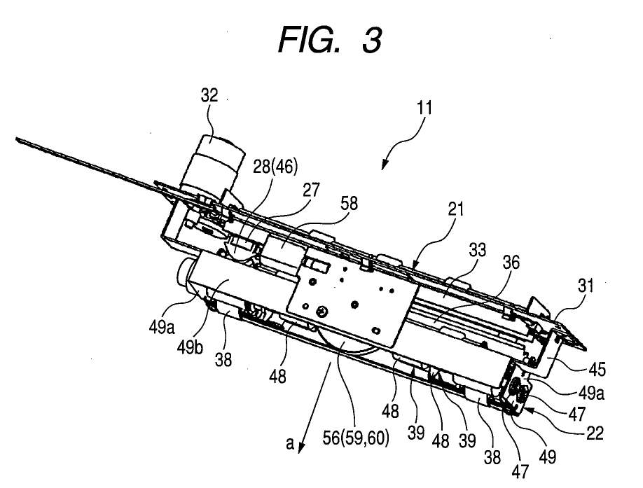

Here, the construction of the cutting unit 11 will be described with reference to FIG. 3 to FIG. 13.

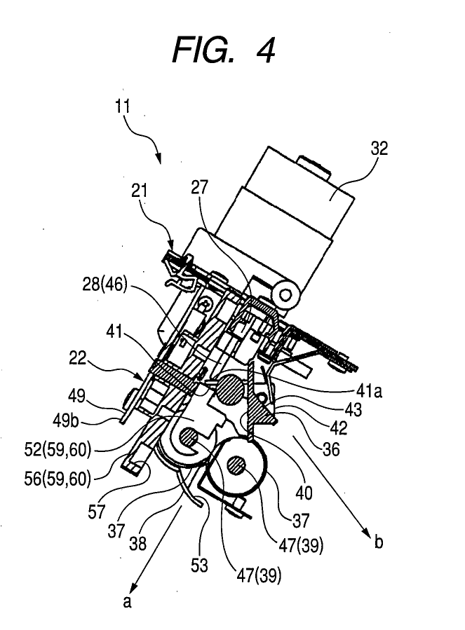

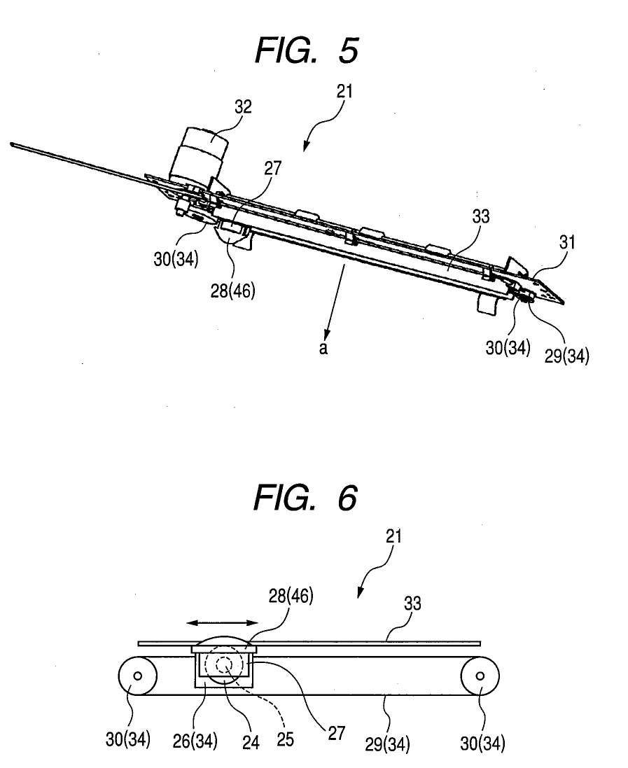

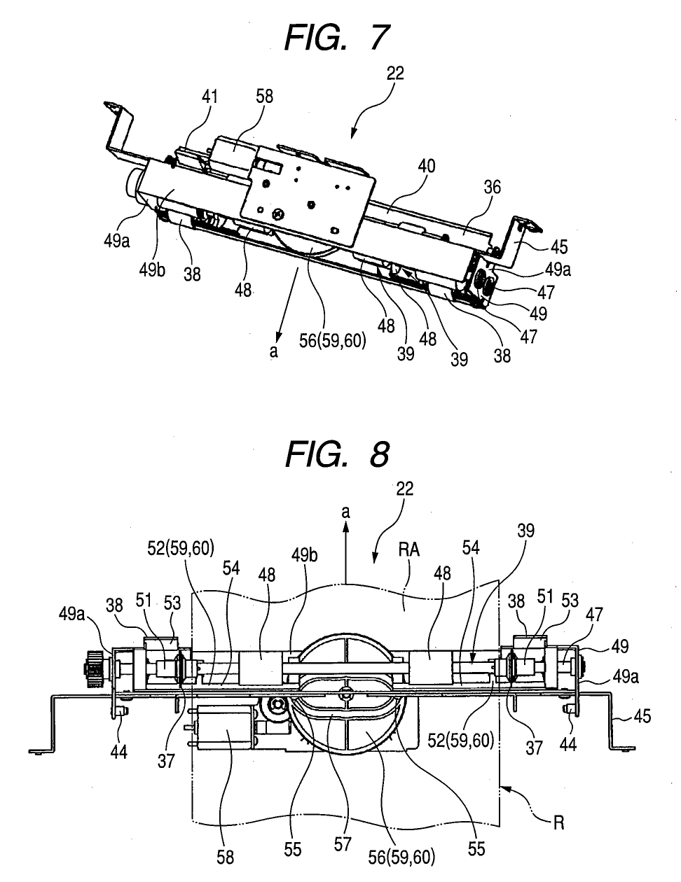

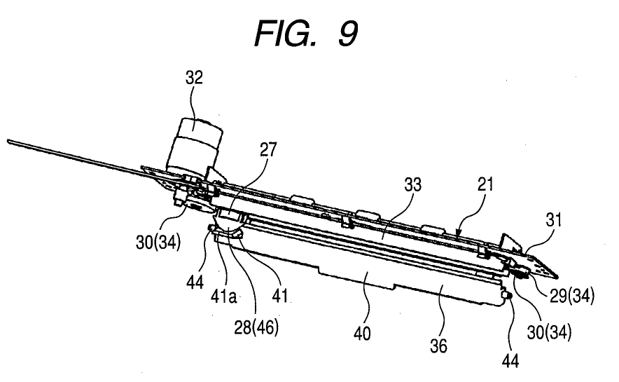

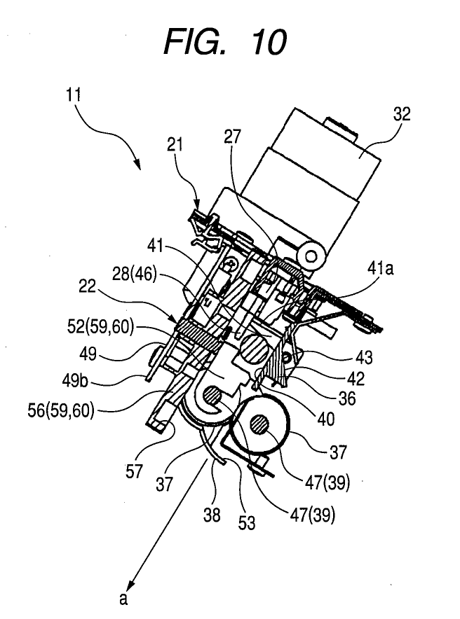

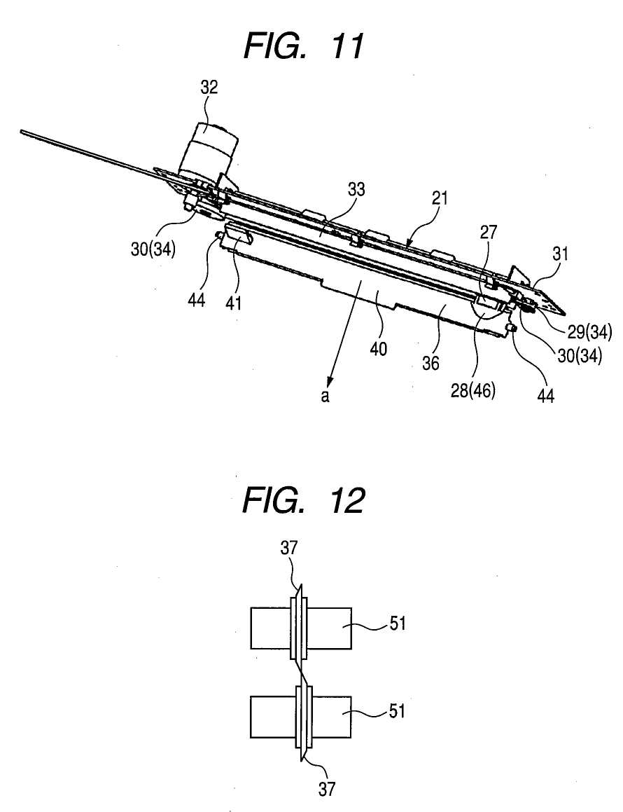

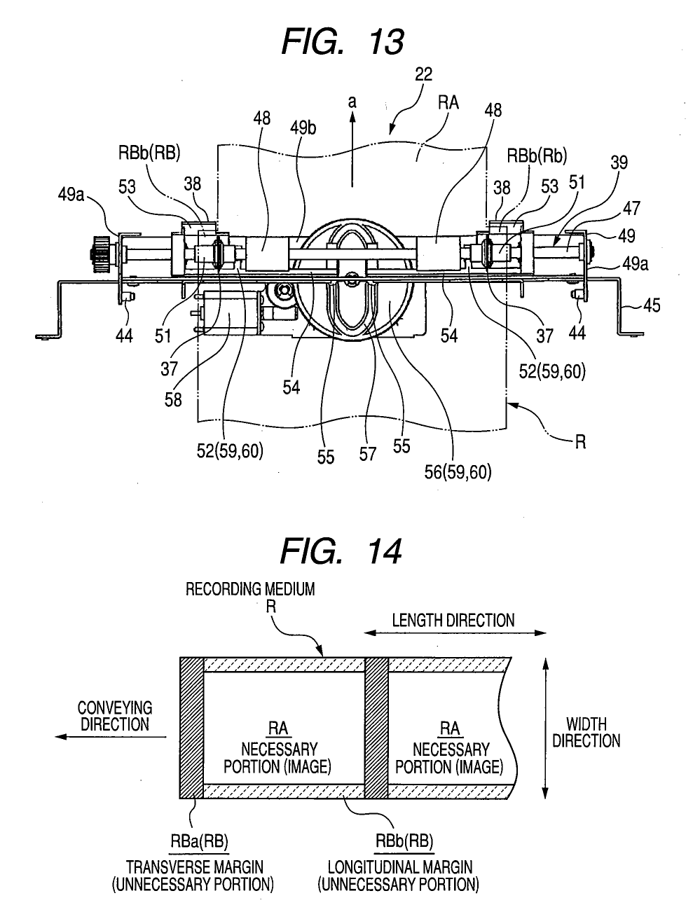

FIG. 3 is an external perspective view showing major portions of the cutting unit, FIG. 4 is an enlarged sectional view of FIG. 3, FIG. 5 is an external perspective view showing major portions of a cutter unit, FIG. 6 is a schematic view showing major portions of a cutter moving means, FIG. 7 is an external perspective view showing major portions of a slitter unit, FIG. 8 is an enlarged bottom view showing major portions of FIG. 7, FIG. 9 is an external perspective view showing major portions in a standby state of a movable guide, FIG. 10 is a sectional view showing major portions in a standby state of the movable guide, FIG. 11 is an external perspective view of major portions in a transverse margin cutting completion state, FIG. 12 is a schematic view showing that the arrangement of a slitter is seen from the upstream side, and FIG. 13 is an enlarged bottom view of major portions in a longitudinal margin cutting state.

As shown in FIG. 3 and FIG. 4, the cutting unit 11 of this embodiment has a cutter unit 21 and a slitter unit 22. Also, the slitter unit 22 is attached to and integrated with the downstream side of the cutter unit 21 in the conveying direction indicated by an arrow a of FIG. 3, by means of screws (not shown). That is, the slitter unit 22 is attached to and integrated with the downstream side of the cutter unit 21 in the conveying direction, thereby forming the cutting unit 11.

The cutter unit 21, as shown in FIG. 3 to FIG. 6, has a cutter 24 (FIG. 6) for cutting the roll sheet R along the width direction orthogonal to its longitudinal direction, i.e., along the direction orthogonal to the conveying direction.

A rotary round blade is used as the cutter 24 of this embodiment. Also, the cutter 24, as shown in FIG. 6, has a hole (not shown) formed at the center thereof inserted into one end of a cutter supporting shaft 25, and is rotatably attached thereto. The other end of the cutter supporting shaft 25 is attached to one surface of a carriage 26 formed substantially in the shape of a flat plate as a whole, and arranged on the downstream side in the conveying direction. Further, a cutter cover 27 which covers the cutter 24 such that its lower portion is exposed is detachably attached to one surface of the carriage 26. Further, a chevron cam 28 which is substantially chevron-shaped in plan view is formed in the vicinity of an upper portion of one surface of the cutter cover 27 such that its tip protrudes toward the downstream side of the roll sheet R in the conveying direction.

The carriage 26 is attached to a preset position of a toothed belt 29, and the toothed belt 29 is hung over a pair of right and left toothed belt pulleys 30 and 30 which are arranged at an interval. The toothed belt pulleys 30 and 30 are rotatably supported in the vicinity of both ends, in the longitudinal direction shown in the right-left direction horizontal direction of FIG. 6, of one surface of a cutter attaching frame 31 (FIG. 5) which is formed substantially in the shape of a flat plate as a whole. Further, one belt pulley, shown on the left of FIG. 6, of the pair of right and left toothed belt pulleys 30 and 30 is formed so as to be rotationally driven by the driving force of a motor 32 for a cutter, such as a pulse motor, which is attached to the other surface of the cutter attaching frame 31 arranged on the upstream side in the conveying direction.

Accordingly, by making the motor 32 for a cutter rotate, the carriage 26 is formed so as to be reciprocable beyond the width of the roll sheet R as indicated by a double-headed arrow of FIG. 6 along the guide plate 33 attached to the cutter attaching frame 31. As a result, the cutter 24 is formed so as to be reciprocable in a travel range exceeding the width of a recording medium in the width direction orthogonal to the longitudinal direction of the roll sheet R, i.e., in the direction orthogonal to the conveying direction indicated by the arrow a of FIG. 3.

The carriage 26, the toothed belt pulleys 30 and 30, and the toothed belt 29 constitute a cutter moving means 34 for reciprocating the cutter 24 of this embodiment along the width direction of the recording medium.

Accordingly, the motor 32 for a cutter is used as a driving source for driving the cutter moving means 34.

Further, a scalpel or a knife may be used as the cutter 24. In this case, it is preferable that a receiving plate of the scalpel or the knife be arranged along the movement locus of the scalpel or the knife.

The slitter unit 22, as shown in FIG. 3, FIG. 4, and FIG. 7, has a movable guide 36, a slitter 37, a moving guide 38, and a conveying roller 39 for a cutting section as a conveying means for a cutting section. Also, the movable guide 36, the slitter 37, and the moving guide 38 are arrayed in this order along the conveying direction indicated by the arrow a.

The movable guide 36 is provided to guide the transverse margins RBa which are the unnecessary portions RB of the roll sheet R cut by the cutter 24 toward the garbage box 12 arranged in the discarding section 6 preset inside the printer body 2, and is its top surface is formed in the shape of a flat plate. The length of this movable guide 36 is formed to be larger than the width of the roll sheet R, and the longitudinal middle portion of the top surface of the movable guide is used as a guide surface 40 which guides the roll sheet R. Also, an operating body 41 is protrudingly provided in a position out of the guide surface 40 in the vicinity of a left end of the top surface. Further, an inclined surface 42 separated from a bottom surface of the movable guide 36 toward the downstream side in the conveying direction is formed on the downstream side of the bottom surface in the conveying direction, and a substantially V-shaped transverse margin guide surface 43 is constituted by a bottom surface leading surface located on the upstream side of the bottom surface in the conveying direction, and the inclined surface 42 continuous therewith.

One end of a guide supporting pin 44 (FIG. 9) is fitted into each of middle portions of both longitudinal end surfaces of the movable guide 36, and the movable guide 36 is rotatably supported with both the guide supporting pins 44 as centers. The other ends of the guide supporting pins 44 are supported by the back surface of the slitter attaching frame 45 disposed on the upstream side in the conveying direction (FIG. 8). Further, the movable guide 36 is biased in the clockwise direction of FIG. 4 by the biasing force of a biasing spring including a torsion coil spring (not shown) whose body is fitted to an outer periphery of the guide supporting pin 44.

The movable guide 36, as shown in FIG. 4 and FIG. 9, is normally in a standby state where the chevron cam 28 of the cutter cover 27 is abutted on an abutting surface 41a of the operating body 41 located on the upstream side in the conveying direction, and as shown in FIG. 4, is in a state where the transverse margin guide surface 43 can block the conveying path so as to become a wall, and thereby guide the transverse margins RBa which are the unnecessary portions RB of the roll sheet R cut by the cutter 24 in the direction indicated by the arrow b, i.e., toward the garbage box 12 arranged in the discarding section 6, i.e., in a guiding state where the conveying path for a recording medium is blocked.

Further, the chevron cam 28 is formed so as to be separated from the abutting surface 41a during movement of the cutter 24 when the unnecessary portions RB of the roll sheet R are cut by the cutter 24. If the chevron cam 28 is separated from the abutting surface 41a, the movable guide 36 will rotate in the clockwise direction of FIG. 4 with the guide supporting pin 44 as centers by the biasing force of biasing springs. The rotation of the movable guide 36 is prevented by a stopper (not shown). As shown in FIG. 10, the guide surface 40 of the movable guide 36 is in a state of being parallel to the conveying path of the roll sheet R. As a result, the guide surface 40 is arranged so as to face the conveying path of the roll sheet R from below, and is in a state where the necessary portions RA of the roll sheet R in a state where the transverse margins RBa have been removed by the cutter 24 can be conveyed along the conveying direction indicated by the arrow a, i.e., in a conveying state where the guide surface faces the conveying path.

In addition, an external perspective view of major portions in the transverse margin cutting completion state after the cutter 24 has moved beyond the width of the roll sheet R, and has cut the roll sheet R in the width direction is shown in FIG. 11.

A guide driving means 46 which make the movable guide 36 of this embodiment driven by the chevron cam 28 in an interlocking manner with the movement of the cutter 24 such that the movable guide selectively takes two positions including a conveying position (FIG. 10: the necessary portions RA can be conveyed in the conveying direction indicated by the arrow a: the longitudinal margins RBb may be included) where the movable guide faces the conveying path so that the roll sheet R can move along the conveying path, and a guiding position (FIG. 4: the transverse margin can be guided in the conveying direction indicated by the arrow b) where the conveying path is blocked is constructed.

A pair of conveying rollers 39 for a cutting section which face each other in the up-down direction via the conveying path are arranged on the downstream side in the conveying direction of the slitter attaching frame 45 indicated by the arrow a such that its axial center extends in the direction orthogonal to the conveying direction, i.e., parallel to the width direction of a recording medium. Each of the conveying rollers 39 for a cutting section is formed by arranging two cylindrical roller bodies 48 which can contact a recording medium at an interval at an outer peripheral surface of a rotary shaft 47 (FIG. 8). Also, both ends of the rotary shaft 47 are rotatably supported by a pair of right and left side plates 49a of a sub-frame 49 disposed at the surface of the slitter attaching frame 45 located on the downstream side in the conveying direction. Moreover, both ends of the rotary shaft 47 protrude from the side plated 49a. Further, outer peripheral surfaces the roller bodies 48 of each of both the conveying rollers 39 for a cutting section face the outer peripheral surfaces of the facing roller bodies 48 so that the roll sheet R can be sandwiched.

Accordingly, the pair of conveying rollers 39 for a cutting section are used as a conveying means for a cutting section for conveying the necessary portions RA of the roll sheet R which have passed through the cutter unit 21 to the downstream side in the conveying direction indicated by the arrow a.

As for both the conveying rollers 39 for a cutting section, one is a driving roller, and the other one is a driven roller, or both are coupling driving rollers. A driving motor for conveyance (not shown) is connected to at least one end of the driving roller via a rotation transmission mechanism (not shown), such as gear transmission, V-belt transmission, and transmission of the toothed belt 29. The driving roller is enabled to be rotationally driven by the driving force of the driving motor for conveyance, and the driven roller receives the driving force from the driving roller and is driven and rotated. Also, the roll sheet R can be conveyed by rotating the conveying rollers 39 for a cutting section in the conveying direction indicated by the arrow a. In addition, the driven roller is formed so as to rotate in the direction opposite to the rotational direction of the driving roller.

The slitter attachment bodies 51 which are formed in a cylindrical shape are respectively fitted outside attachment positions of the roller bodies 48 at an outer periphery of the rotary shaft 47. Also, each slitter attachment body 51 is formed so as to be movable along the rotary shaft 47 on the rotary shaft 47, and be integrally rotatable with the rotary shaft 47, by teeth and grooves, such as splines or serrations (not shown), which are formed at mutually facing surfaces between an inner hole of the slitter attachment body 51, and the outer peripheral surface of the rotary shaft 47 (FIG. 8). Accordingly, the slitter 37 is adapted to be rotate in the same direction in an interlocking manner with the rotation of the conveying roller 39 for a cutting section.

The slitter 37 is arranged substantially at a longitudinal middle portion of the outer peripheral surface of the slitter attachment body 51.

The slitter 37 is provided to cut the roll sheet R along its longitudinal direction. In this embodiment, a rotary round blade is used as the slitter. Also, the slitter 37 is detachably attached such that its central portion is fitted to an outer periphery of the slitter attachment body 51 which is formed in a cylindrical shape.

The slitters 37 of both the conveying rollers 39 for a cutting section are arranged such that the end faces of a cutting portion provided at an outer periphery of the slitter 37 disposed in one conveying roller 39 for a cutting section via the conveying path and an end surface of a cutting portion provided at an outer periphery of the slitter 37 disposed in the other conveying roller 39 for a cutting section face each other (FIG. 4 and FIG. 10).

A schematic view shown that the arrangement of the slitter 37 is seen from the upstream side is shown in FIG. 12.

Accordingly, in this embodiment, two slitters (a total of four) 37 are disposed in each of one pair of upper and lower conveying rollers 39 for a cutting section, and slitters 37 are formed so as to rotate along with the conveying roller 39 for a cutting section.

The slitter attachment bodies 51 which face each other via the conveying path, among the slitter mounting bodies 51 disposed in both the conveying rollers 39 for a cutting section, are connected by sliders 52, respectively.

Accordingly, the sliders 52 are arranged at one end and other end of the rotary shaft 47. Also, the sliders 52 are attached to one rotary shaft 47 shown on the left (upper side of FIG. 7) of FIG. 4 so as to be movable along the direction of its axis. Further, both the sliders 52, and two slitters 37 disposed in one conveying roller 39 for a cutting section are arranged plane-symmetrically so as to face each other with an imaginary elevational plane including a substantially longitudinal middle portion of the rotary shaft 47, and specifically, a middle portion, in the width direction, of a recording medium which is conveyed along the conveying path as an imaginary plane of symmetry. In addition, the roller bodies 48 as well as the sliders 52 are similarly arranged plane-symmetrically.

The moving guides 38 are formed in both the sliders 52 so as to extend therefrom. Each moving guide 38 is provided to guide the longitudinal margins RBb (refer to FIG. 14) which are the unnecessary portions RB of the roll sheet R cut by the slitter 37 toward the garbage box 12, and is formed in the shape of a curved plate having a circular-arc cross-section. The moving guide 38 is arranged such that its inner surface faces the upstream side in the conveying direction, and is arranged on the downstream side in the conveying direction so as to be located more outside in the width direction of the roll sheet R than the slitter 37. Further, the inner surface of the moving guide 38 is used as a longitudinal margin guide surface 53 (FIG. 2, FIG. 4, and FIG. 10).

An arm portion 54 is formed in the slider 52 toward the longitudinal middle portion of the rotary shaft 47. The arm portion 54 extends parallel to the rotary shaft 47, and a cam follower 55 is protrudingly provided at the tip of the arm portion. As the cam follower 55, a columnar or cylindrical pin, or a cam roller is used. Also, the cam follower 55 is engaged with a cam groove 57 formed in the bottom surface of a disk-like cam plate 56 arranged horizontally above the conveying roller 39 for a cutting section. The cam groove 57 is substantially in a elliptical shape as the roll sheet R is longer in its width direction, and is shorter in its longitudinal direction (FIG. 8).

The cam plate 56 is rotatably attached to the bottom surface of a top plate 49b of the sub-frame 49. The rotation center of the cam plate 56 is arranged at the imaginary elevation plane including a middle portion in the width direction of the roll sheet R which is conveyed along the aforementioned conveying path. Further, the cam plate 56 is adapted to be rotatably driven by the driving force of the driving motor 58 for a cam plate attached via a holding frame (not shown) to the slitter attaching frame 45.

Accordingly, the cam follower 55 is displaced along the shape of the cam groove 57 by rotationally driving the cam plate 56 with the driving force of the driving motor 58 for a cam plate. By the displacement of the cam follower 55, the slider 52 can be moved on the rotary shaft 47 along the direction of its axis. At this time, the slitter 37 and the moving guide 38 can be moved along the width direction of the roll sheet R in an interlocking manner with the movement of the slider 52.

As for the slitter 37, as shown in FIG. 8, when the cam follower 55 is located in a large-diameter portion which is radially outward farthest from the center of the cam plate 56 inside the cam groove 57, the spacing between the slitters 37 which face each other in the width direction of the roll sheet R becomes larger than the width of the roll sheet R. As a result, an initial position where each slitter 37 has been separated outward from an end edge of the roll sheet R in the width direction can be held. At this time, the roll sheet R which has passed through the cutter unit 21 is conveyed by one pair of conveying rollers 39 for a cutting section along the conveying direction indicated by the arrow a, and is housed in the tray 13.

As for the slitter 37, when the cam plate 56 make a rotation of 90° degrees from the position shown in FIG. 8, the cam follower 55 is located in a small-diameter portion which is radially inward nearest to the center of the cam plate 56 inside the cam groove 57 as shown in FIG. 13. At this time, each slitter 37 and each moving guide 38 move toward the longitudinal middle portion of the rotary shaft 47 along with the slider 52. The slitter 37 is held in a cutting position where the slitter cuts the roll sheet R, and specifically, the longitudinal margins RBb formed on both sides of the roll sheet R in the width direction along the longitudinal direction. The longitudinal margin guide surface 53 of the moving guide 38 is held in a position where the guide surface blocks the conveying path indicated by the arrow a so as to become a wall. As a result, the longitudinal margins RBb which are the unnecessary portions RB of the roll sheet R cut by the slitter 37 are guided in the direction indicated by the arrow c of FIG. 2, i.e., toward the garbage box 12 arranged in the discarding section 6. The necessary portions RA of the roll sheet R cut by the slitter 37 and having an image formed thereon are guided in the direction indicated by the arrow a, i.e., toward the tray 13 arranged in the medium housing unit 7.

Accordingly, the slitter 37 is formed so as to be movable along the width direction of the roll sheet between two positions including the initial position separated from the roll sheet R as a recording medium, and the cutting position where the roll sheet R is cut along the longitudinal direction. Further, the moving guide 38 is moved along with the slitter 37, and is formed so that it can guide the longitudinal margins RBb as unnecessary portions RB of the roll sheet R cut by the slitter 37 toward the garbage box 12.

The slider 52 and the cam plate 56 constitute the slitter moving means 59 which moves the slitter 37 of this embodiment along the width direction of a recording medium between at least two positions including the initial position separated from the recording medium, and the cutting position where the recording medium is cut in the longitudinal direction.

The slider 52 and the cam plate 56 constitute a moving guide moving means 60 which moves the moving guide 38 of this embodiment in an interlocking manner with the movement of the slitter 37.

That is, the slider 52 and the cam plate 56 of this embodiment are constructed so as to have both the functions of the slitter moving means 59 and the moving guide moving means 60.

Accordingly, the driving motor 58 for a cam plate is used as a driving source for driving the slitter moving means 59 and the moving guide moving means 60.

That is, the driving motor 58 for a cam plate is used as a motor for a slitter for driving the slitter moving means 59.

In addition, a plurality of cutting positions can be provided by changing the angle of rotation when the cam plate 56 has stopped. Of course, the shape of the cam groove 57 may be changed.

Further, only the longitudinal margin RBb formed at one end of both ends of a recording medium in its width direction can also be cut in the longitudinal direction by removing one of the two slitters 37 disposed in one rotary shaft 47.

The printer 1 of this embodiment is provided with a control means which is not shown. This control means is provided to manage the control of the operation of each section, and is mainly constituted by a CPU and memories. Also, various driving sources including at least the motor 32 for a cutter and the driving motor 58 for a cam plate which are mentioned above, various switches, such as a power switch, an operation switch, and an input switch used for the input of information, display means, such a display panel, and various sensors used for detection of various operations, detection of positions, etc. are electrically connected to the control means. Also, the operation sequence, operation timing, driving amount, etc. of various driving sources including at least the motor 32 for a cutter and the driving motor 58 for a cam plate which are mentioned above are controlled on the basis of programs stored in the memories in advance, according to control commands sent out from the control means.

In addition, as the cutting unit 11, a construction in which the slitter unit 22 is easily and individually made attachable may be adopted. In a case where such a construction is adopted, it is important to make the movable guide 36 supported by the cutter unit 21, for example, the cutter attaching frame 31. Also, the slitter unit 22 can be made optionally by individually and detachably constructing the slitter unit 22. As a result, since the slitter unit can use not only in the specification in which the transverse margins RBa and the longitudinal margins RBb are generated but for the specification in which only the transverse margins RBa are generated, its versatility is improved.

Of course, as the cutting unit 11, a construction of only the cutter unit 21 can be adopted. That is, since the slitter unit 22 is not required in the case of the specification in which the longitudinal margins RBb are not generated, it is not necessary to provide the slitter unit 22. Even in a case where such a construction is adopted, it is important to make the movable guide 36 supported by the cutter unit 21, for example, the cutter attaching frame 31.

Since other constructions are the same as those of a printer well-known in the related art, detailed description thereof is omitted herein.

Next, the operation of this embodiment constructed as mentioned above will be described.

In addition, since the control of various operations, such as the recording operation of forming an image on a recording medium, is the same as that in the related art, only the cutting operation of the recording medium which is a subject matter of the invention will be described below.

According to the printer 1 of this embodiment, the roll sheet R as a roll-like recording medium on which an image has been recorded can be surely cut along the width direction orthogonal to the longitudinal direction of the roll sheet R by the cutter 24, and can be surely cut along the longitudinal direction of the roll sheet R by the slitter 37.

Further, according to the printer 1 of this embodiment, the movable guide 36 which guides the unnecessary portions RB of the roll sheet R cut by the cutter 24 toward the garbage box 12 arranged in the discarding section 6 preset inside the printer body 2, and the moving guide 38 which guides the unnecessary portions RB of the roll sheet R cut by the slitter 37 toward the garbage box 12 are provided. Thus, the movable guide 36 an separate the unnecessary portions RB cut by the cutter 24 from the necessary portions RA to surely guide them toward the garbage box 12, and the moving guide 38 can separate the unnecessary portions RB cut by slitter 37 from the necessary portions RA to surely guide them toward the garbage box 12.

Accordingly, according to the printer 1 of this embodiment, it is possible to surely and easily separate the unnecessary portions RB of the roll sheet R from the necessary portions RA to guide them toward the garbage box 12.

Further, according to the printer 1 of this embodiment, the cutter 24 and the movable guide 36 are integrated, thereby forming the cutter unit 21, the slitter 37 and the moving guide 38 are integrated, thereby forming the slitter unit 22, and the slitter unit 22 is attached to and integrated with the downstream side of the cutter unit 21 in the conveying direction of the recording medium, miniaturization and assembling workability can be easily improved.

Further, according to the printer 1 of this embodiment, the cutter 24 can be surely reciprocated along the width direction of the roll sheet R by driving the motor 32 for a cutter, and the movable guide 36 can be driven by the guide driving means 46 in an interlocking manner with the movement of the cutter 24 such that the movable guide selectively takes two positions including a conveying position where the movable guide faces the conveying path so that the roll sheet R can move along the conveying path, and a guiding position where the conveying path of the roll sheet R is blocked. As a result, the roll sheet R can be surely cut along the width direction orthogonal to the longitudinal direction, and the unnecessary portions RB of the roll sheet R cut by the cutter 24 can be surely and easily guided toward the garbage box 12 arranged in the discarding section 6 preset inside the printer body 2.

Further, according to the printer 1 of this embodiment, by driving the driving motor 58 for a cam plate is driven, the slitter moving means 59 can move surely and easily move the position of the slitter 37 such that the slitter selectively takes two positions including the initial position separated from the recording medium R, and the cutting position where the recording medium R is cut in the longitudinal direction, and the position of the moving guide 38 can be surely and easily moved in an interlocking manner with the slitter 37. As a result, in a case where it is necessary to cut the roll sheet R in the longitudinal direction, for example, in a case where an image of 5-inch width has been recorded on a roll sheet R of 6-inch width, the driving motor 58 for a cam plate is driven, and the holding slitter 37 is moved to and held in the cutting position. Thereby, the roll sheet R can be surely and easily cut along the longitudinal direction, and the longitudinal margins RBb which are the unnecessary portions RB of the roll sheet R cut by slitter 37 can be surely and easily guided toward the garbage box 12 arranged in the discarding section 6 preset inside the printer body 2. Of course, in a case where it is not necessary to cut the roll sheet R, the slitter 37 can be located in the initial position, and can be easily and surely held therein.

Further, according to the printer 1 of this embodiment, since the conveying rollers 39 for a cutting section as a conveying means for a cutting section are provided, the necessary portions RA of the roll sheet R which have passed through the cutter unit 21 can be surely and easily conveyed to the downstream side in the conveying direction indicated by the arrow a. As a result, the necessary portions RA of the roll sheet R after cutting can be easily and surely conveyed toward the tray 13 arranged in the medium housing unit 7.

In addition, the invention is not limited to the aforementioned embodiment, and various changes thereof can be made, if necessary.

It should be understood by those skilled in the art that various modifications, combinations, sub-combinations and alternations may occur depending on design requirements and other factors insofar as they are within the scope of the appended claims of the equivalents thereof.

1. A printer comprising a cutter disposed inside a printer body to cut a roll-like recording medium having an image recorded thereon along a width direction orthogonal to a longitudinal direction of the recording medium, and a slitter cutting the recording medium in its longitudinal direction,
wherein the cutter is formed so as to be reciprocable along the width direction of the recording medium, and is formed such that the recording medium is cut along the width direction by the movement of the cutter in the width direction,
wherein the slitter is formed so as to be movable along the width direction of the recording medium such that the slitter selectively takes at least two positions including an initial position separated outward from an end edge of the recording medium in the width direction, and a cutting position where the recording medium is cut along the longitudinal direction, and is formed such that the recording medium is cut along the longitudinal direction by conveying the recording medium in a state where the position of the slitter is moved to the cutting position, and
wherein a movable guide made movable in an interlocking manner with the movement of the cutter and guiding unnecessary portions of the recording medium cut by the cutter toward a garbage box arranged in a discarding section preset inside the printer body, and a moving guide moved along with the slitter and guiding unnecessary portions of the recording medium cut by the slitter toward the garbage box.

2. The printer according to claim 1,
wherein the cutter is unified to form a cutter unit,
the movable guide, the slitter and the moving guide are unified to form a slitter unit, in a state of being arranged in this order along a conveying direction of the recording medium, and
the slitter unit is attached to the downstream side of the cutter unit in the conveying direction of the recording medium and is integrated with the cutter unit to form a cutting unit.

3. The printer according to claim 2,
wherein the cutter unit is provided with
a cutter moving means reciprocating the cutter along the width direction of the recording medium,
a motor for a cutter driving the cutter moving means, and
a guide driving means driving the moving guide in an interlocking manner with the movement of the cutter such that the movable guide selectively takes two positions including a conveying position where the movable guide faces the conveying path so that the recoding medium can move along the conveying path, and a guiding position where the conveying path of the recording medium is blocked,
wherein the slitter unit is provided with
a slitter moving means moving the slitter along the width direction of the recording medium between at least two positions including the initial position and the cutting position,
a motor for a slitter driving the slitter moving means,
a moving guide moving means moving the moving guide in an interlocking manner with the movement of the slitter, and
a conveying means for a cutting section conveying necessary portions of the recording medium passed through the cutter unit to the downstream side in the conveying direction of the recording medium.
